(19) United States
(12) Patent Application Publication
(10) Pub. No.: US 2017/0257367 A1
(43) Pub. Date: Sep. 7, 2017

(54) ELECTRONIC DEVICES AND METHOD FOR PERFORMING AUTHENTICATION BETWEEN ELECTRONIC DEVICES

(71) Applicant: Electronics and Telecommunications Research Institute, Daejeon (KR)

(72) Inventors: Jin-Hee HAN, Daejeon (KR); Dae-Won KIM, Daejeon (KR); Young-Sae KIM, Daejeon (KR); Yong-Hyuk MOON, Daejeon (KR); Seung-Yong YOON, Daejeon (KR); Jae-Deok LIM, Sejong (KR); Jeong-Nyeo KIM, Daejeon (KR); Yong-Sung JEON, Daejeon (KR)

(21) Appl. No.: 15/360,950

(22) Filed: Nov. 23, 2016

(30) Foreign Application Priority Data
Mar. 7, 2016 (KR) 10-2016-0026828

(51) Int. Cl. H04L 29/06; H04W 12/06

(52) U.S. Cl. CPC H04L 63/0869; H04L 63/0853; H04W 12/06

(57) ABSTRACT

Disclosed herein is an electronic device including a message creation unit for creating an authentication message that includes hardware information and security level information for mutual authentication with an additional electronic device; a communication unit for sending the authentication message to the additional electronic device and receiving an authentication message of the additional electronic device from the additional electronic device; an authentication algorithm selection unit for selecting an authentication algorithm for mutual authentication with the additional electronic device based on hardware information and security level information of the additional electronic device, which are included in the authentication message of the additional electronic device; and an authentication processing unit for performing a mutual authentication process using the selected authentication algorithm.

### CROSS REFERENCE TO RELATED APPLICATION

This application claims the benefit of Korean Patent Application No. 10-2016-0026828, filed Mar. 7, 2016, which is hereby incorporated by reference in its entirety into this application.

### BACKGROUND OF THE INVENTION

1. Technical Field

The present invention relates to an electronic device and a method for performing authentication between electronic devices.

2. Description of the Related Art

The Internet of Things (IoT), in which intelligent services are provided in such a way that smart objects are interconnected via various networks so as to enable humans and objects or an object and another object to mutually communicate, is receiving attention as a promising technology for realizing a hyper-connected society by being integrated with mobile technology, cloud technology, big data technology and the like. However, with the spread of IoT services, it is necessary to consider the possibility of various security threats, such as the transfer of malware between devices, the threat of attacks by malware, the spread of damage to cross-network devices, and the like, when communication between various devices, interconnection between heterogeneous networks, or the like is performed.

Currently, technology for performing mutual authentication between IoT devices in consideration of the characteristics of an IoT environment, in which IoT devices having various hardware specifications and different security levels are interconnected through the Internet, is at an early stage of development. Specifically, lightweight authentication protocols, techniques for authentication between lightweight devices based on lightweight authentication protocols, mutual authentication techniques and key exchange protocols for secure Machine-to-Machine (M2M) communication, and the like have been researched, but the implementation thereof has merely been proposed in research papers, and these techniques are not sufficiently developed to be applied to an actual service environment.

Also, conventional mutual authentication techniques have been individually developed and applied to be adapted for the hardware specifications and characteristics of devices depending on whether the devices are low-performance devices or high-performance devices. Therefore, if a secure application is run by using a low-performance device and a high performance device without a help of other devices, there may be a need for a mutual authentication method between two devices that may communicate with each other conveniently and securely.

### SUMMARY OF THE INVENTION

An object of the present invention is to provide electronic devices capable of performing convenient and secure mutual authentication and a method for performing mutual authentication between electronic devices when the devices communicate with each other in an IoT environment.

The technical objects of the present invention are not limited to the above-mentioned object, and other technical objects that have not been mentioned will be clearly understood from the following description by those skilled in the art.

An electronic device according to an embodiment of the present invention may include a message creation unit for creating an authentication message including hardware information and security level information for mutual authentication with an additional electronic device; a communication unit for sending the authentication message to the additional electronic device and receiving an authentication message of the additional electronic device from the additional electronic device; an authentication algorithm selection unit for selecting an authentication algorithm for mutual authentication with the additional electronic device based on hardware information and security level information of the additional electronic device, which are included in the authentication message of the additional electronic device; and an authentication processing unit for performing a mutual authentication process using the selected authentication algorithm.

In an embodiment, the authentication message created by the message creation unit may further include at least one of information about a random number for mutual authentication with the additional electronic device and identification information of the electronic device.

In an embodiment, the communication unit may send information about the selected authentication algorithm to the additional electronic device.

In an embodiment, the hardware information may include information about characteristics of resources of the electronic device or IoT device type information of the electronic device.

In an embodiment, the hardware information may be defined differently depending on the information about the characteristics of the resources of the electronic device or the IoT device type information of the electronic device.

In an embodiment, the security level information may have different values depending on a security level of the electronic device.

In an embodiment, the security level information may be hierarchically defined depending on the security level of the electronic device.

An electronic device according to an embodiment of the present invention may include a message creation unit for creating an authentication message including hardware information and security level information for mutual authentication with an additional electronic device; a communication unit for sending the authentication message to the additional electronic device and receiving an authentication message of the additional electronic device and information about a mutual authentication algorithm selected by the additional electronic device from the additional electronic device; an authentication algorithm selection unit for selecting an authentication algorithm for mutual authentication with the additional electronic device based on hardware information and security level information of the additional electronic device, which are included in a message of the additional electronic device; and an authentication processing unit for performing a mutual authentication process by comparing the selected authentication algorithm with the information about the mutual authentication algorithm received from the additional electronic device.

In an embodiment, the authentication processing unit may perform the mutual authentication process when the selected authentication algorithm matches a mutual authentication algorithm based on the information about the mutual authentication algorithm received from the additional electronic device.

In an embodiment, when the selected authentication algorithm is not identical to a mutual authentication algorithm based on the information about the mutual authentication algorithm received from the additional electronic device, the authentication processing unit may send a message indicating a mismatch between the selected authentication algorithm and the mutual authentication algorithm to the additional electronic device through the communication unit.

In an embodiment, when a number of cases in which the selected authentication algorithm is not identical to an authentication algorithm, based on mutual authentication algorithm information repeatedly received from the additional electronic device, is greater than a predetermined number, the authentication processing unit may stop performance of the mutual authentication process.

A method for mutual authentication between electronic devices according to an embodiment of the present invention may include creating, by a first electronic device, a first authentication message including first hardware information and first security level information for mutual authentication and sending, by the first electronic device, the first authentication message to a second electronic device; creating, by the second electronic device, a second authentication message including second hardware information and second security level information for mutual authentication and sending, by the second electronic device, the second authentication message to the first electronic device; selecting, by the first electronic device, a first authentication algorithm for mutual authentication with the second electronic device based on the second hardware information and the second security level information; selecting, by the second electronic device, a second authentication algorithm for mutual authentication with the first electronic device based on the first hardware information and the first security level information; sending, by the first electronic device, information about the selected first authentication algorithm to the second electronic device; and performing, by the second electronic device, a mutual authentication process by comparing the information about the first authentication algorithm with information about the selected second authentication algorithm.

In an embodiment, the first authentication message may further include at least one of information about a random number for mutual authentication with the second electronic device and identification information of the first electronic device, and the second authentication message may further include at least one of information about a random number for mutual authentication with the first electronic device and identification information of the second electronic device.

In an embodiment, the method may further include performing, by the first electronic device, the mutual authentication process using the selected first authentication algorithm.

In an embodiment, performing, by the second electronic device, the mutual authentication process may be configured to perform the mutual authentication process when the information about the selected second authentication algorithm matches the information about the first authentication algorithm.

In an embodiment, performing, by the second electronic device, the mutual authentication process may be configured such that, when the information about the selected second authentication algorithm is not identical to the information about the first authentication algorithm, a message indicating a mismatch between the two pieces of information is sent to the first electronic device.

In an embodiment, when the first electronic device receives the message indicating the mismatch from the second electronic device, selecting the first authentication algorithm may be repeatedly performed, but an authentication algorithm other than the first authentication algorithm may be selected.

In an embodiment, performing, by the second electronic device, the mutual authentication process may be configured to stop the mutual authentication process when a number of cases in which information about the newly selected authentication algorithm is not identical to the information about the second authentication algorithm is greater than a predetermined number.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram that shows a system for mutual authentication between electronic devices according to an embodiment of the present invention;

FIG. 2 is a diagram that shows a method for mutual authentication between electronic devices according to an embodiment of the present invention;

FIG. 3 shows hardware information and information about security levels according to an embodiment of the present invention;

FIG. 4 is a flowchart that shows a method for mutual authentication between electronic devices according to an embodiment of the present invention;

FIG. 5 is a block diagram that shows a first electronic device according to an embodiment of the present invention; and

FIG. 6 is a block diagram that shows a second electronic device according to an embodiment of the present invention.

### DESCRIPTION OF THE PREFERRED EMBODIMENTS

Hereinafter, embodiments of the present invention will be described in detail with reference to the accompanying drawings. It should be noted that the same reference numerals are used to designate the same or similar elements throughout the drawings. In the following description of the present invention, detailed descriptions of known functions and configurations which are deemed to make the gist of the present invention obscure will be omitted.

Various terms, such as “first”, “second”, “A”, “B”, “(a)”, “(b)”, etc., can be used to differentiate one component from the other, but the substances, order or sequence of the components are not limited by the terms. Unless differently defined, all terms used here, including technical or scientific terms, have the same meanings as the terms generally understood by those skilled in the art to which the present invention pertains. Terms identical to those defined in generally used dictionaries should be interpreted as having meanings identical to contextual meanings of the related art, and are not to be interpreted as having ideal or excessively formal meanings unless they are definitely defined in the present specification.

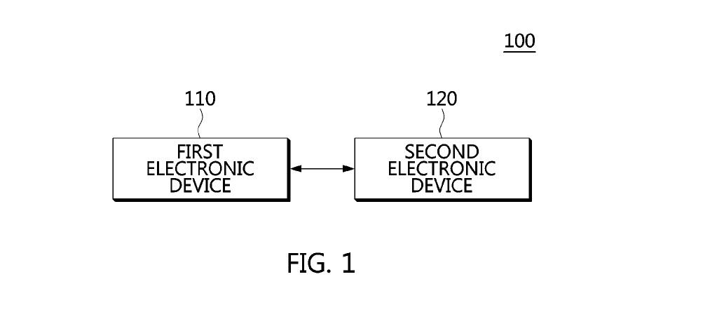

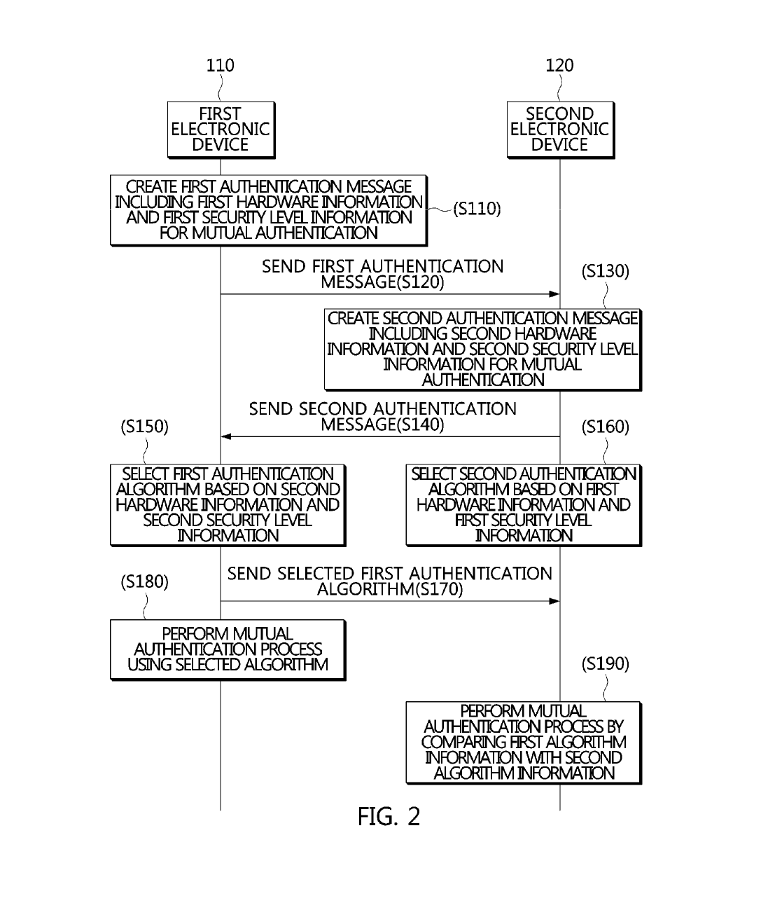

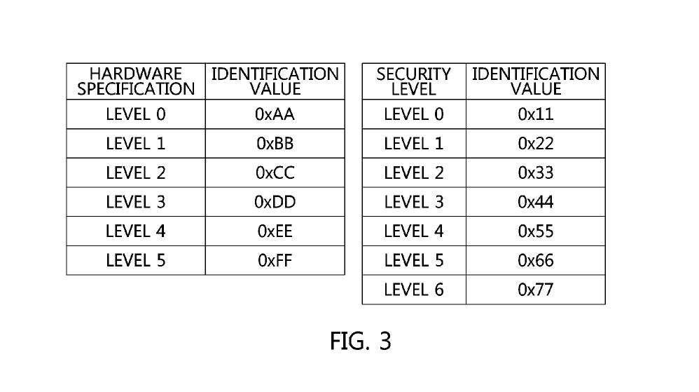

FIG. 1 is a block diagram that shows a system for mutual authentication between electronic devices according to an embodiment of the present invention. FIG. 2 is a diagram that shows a method for mutual authentication between electronic devices according to an embodiment of the present invention. FIG. 3 shows hardware information and information about security levels according to an embodiment of the present invention.

First, referring to FIG. 1, a system 100 for mutual authentication between electronic devices according to an embodiment of the present invention may include a first electronic device 110 and a second electronic device 120. FIG. 1 shows an example in which the mutual authentication system 100 includes two electronic devices, but without limitation thereto, the system may include a different number of electronic devices.

The first electronic device 110 and the second electronic device 120 may be connected to the Internet via a gateway (not illustrated), or may be connected to the Internet using a cable or in a wireless manner. Here, the electronic devices 110 and 120 may be a device for providing various services to users by interworking with a cloud server or a service provider server. The first electronic device 110 and the second electronic device 120 may be connected with each other through the IoT, and may individually perform an authentication process when they are connected with each other.

The first electronic device 110 and the second electronic device 120 select an algorithm for mutual authentication based on hardware information and information about a security level, and may perform a mutual authentication process using the selected authentication algorithm. Hereinafter, these processes will be described in detail with reference to FIG. 2 and FIG. 3.

Referring to FIG. 2 and FIG. 3, the first electronic device 110 may create a first authentication message that includes first hardware information and first security level information for mutual authentication at step S110.

For example, the first authentication message may be configured such that a field is added to a message that is generally sent and received between IoT devices so as to include the first hardware information and the first security level information therein. The first authentication message may include at least one of information about a random number for mutual authentication with the second electronic device 120 and identification information of the first electronic device 110.

The first hardware information may indicate information about the hardware specification of the first electronic device 110, and the first security level information may indicate information about the security level of the first electronic device 110.

The first hardware information may include information about the characteristics of the resources or information about the IoT device type of the first electronic device 110. For example, the information about the characteristics of the resources may comprise information about the three classes (class 0, class 1, and class 2) into which electronic devices having limited resources are classified by the Internet Engineering Task Force (IETF) based on the data size and code size of the device. Also, the information about the IoT device type may comprise information about the four IoT device types (a data-carrying device, a data-capturing device, a sensing and actuating device and a general device) classified by the International Telecommunication Union Telecommunication Standardization Sector (ITU-T). Further, the information about the IoT device type may be used by developers who classifies and defines hierarchy such as a low-performance device or a high-performance device based on information of a processor in a device (Cortex-M0, Cortex-M3, Cortex-M4, etc.), a size of a memory, and a supported wireless communication protocol. The first hardware information may be defined by assigning a different identification number thereto based on the information about the characteristics of the resources, information about the IoT device type or information about the developer defined device type of the first electronic device 110.

The first security level information may be hierarchically defined depending on the security level of the first electronic device 110, and may be defined so as to have a different value depending on the security level thereof. For example, the first security level information may be defined so as to have different values depending on whether the security level is low, middle or high. Here, the low level of security may be a security level in which a simple mathematical operation function or a hash algorithm is supported, the middle level of security may be a security level in which a symmetric key block encryption algorithm is supported, whereas the high level of security may be a security level in which an asymmetric key algorithm or a device certificate is supported. Further, according to providing software security functions or providing encryption algorithms or security functions by a hardware security module, information about security functions or encryption algorithms may be used as information of security levels hierarchically classified.

By combining information of predetermined hardware and security levels in a various way, a mechanism of a typical authentication algorithm which is provided to each device may be defined. The defined mechanism may be used by classifying and defining hierarchically according to combining hardware information and security level information.

The first electronic device 110 may send the created first authentication message to the second electronic device 120 at step S120.

The second electronic device 120 may create a second authentication message that includes second hardware information and second security level information for mutual authentication at step S130. For example, the second authentication message may be configured such that a field is added to a message that is generally sent and received between IoT devices so as to include the second hardware information and the second security level information therein. The second authentication message may include at least one of information about a random number for mutual authentication with the first electronic device 110 and identification information of the second electronic device 120.

The second hardware information may indicate information about the hardware specification of the second electronic device 120, and the second security level information may indicate information about the security level of the second electronic device 120. The second hardware information and the second security level information may be defined in the same manner as the first hardware information and the first security level information, which have been described above.

The second electronic device 120 may send the created second authentication message to the first electronic device 110 at step S140.

The first electronic device 110 may select a first authentication algorithm for mutual authentication with the second electronic device 120 based on the second hardware information and the second security level information, which are included in the second authentication message, at step S150.

The second electronic device 120 may select a second authentication algorithm for mutual authentication with the first electronic device 110 based on the first hardware information and the first security level information, which are included in the first authentication message, at step S160.

Here, steps S150 and S160 may be simultaneously or sequentially performed, or the performance of step S160 may precede the performance of step S150.

The first electronic device 110 may send information about the selected first authentication algorithm to the second electronic device 120 at step S170.

The first electronic device 110 may perform the process of mutual authentication with the second electronic device 120 using the selected first authentication algorithm at step S180.

Here, steps S170 and S180 may be simultaneously or sequentially performed, or the performance of step S180 may precede the performance of step S170.

The second electronic device 120 compares information about the selected second authentication algorithm with the information about the first authentication algorithm, which is received from the first electronic device 110, and may perform the process of mutual authentication with the first electronic device 110 at step S190.

For example, if a security level of the first low-performance electronic device operated by a Cortex-M0 processor having a small size memory is defined as a security level in which a simple mathematical operation function or hash algorithm is supported and if a security level of the second high-performance electronic device operated by a Cortex-M4 processor having a large size memory is defined as a security level in which not only a simple mathematical operation function but also a symmetric key and an asymmetric key encryption algorithms are supported, the first low-performance electronic device may select an authentication algorithm based on a hash algorithm and send information of the selected authentication algorithm to the second high-performance electronic device referring to hardware specification information and security level information of the first low-performance and the second high-performance electronic devices. In the same way, the second high-performance electronic device may select an authentication algorithm based on a hash algorithm or an authentication algorithm using a simple mathematical operation for an efficient mutual authentication with the first low-performance electronic device referring to hardware specification information and security level information of the first low-performance and the second high-performance electronic devices. The second high-performance electronic device may perform an authentication process if the information of the authentication algorithm sent by the first low-performance electronic device is the same information of the authentication algorithm selected by the second high-performance electronic device. If both information of the authentication algorithms are different, the second high-performance electronic device may send information regarding an authentication algorithm mismatch to the first low-performance electronic device.

As described above, in the method for mutual authentication between electronic devices according to an embodiment of the present invention, an authentication algorithm for mutual authentication is selected using hardware specification information and security level information, and a mutual authentication process is performed based on the selected algorithm, whereby a low-performance electronic device and a high-performance electronic device may conveniently and security perform mutual authentication without the aid of another device.

Also, because the method for mutual authentication between electronic devices according to an embodiment of the present invention enables mutual authentication between electronic devices to be autonomously performed, the involvement of an administrator or a user may be minimized, and multiple IoT devices may be effectively managed.

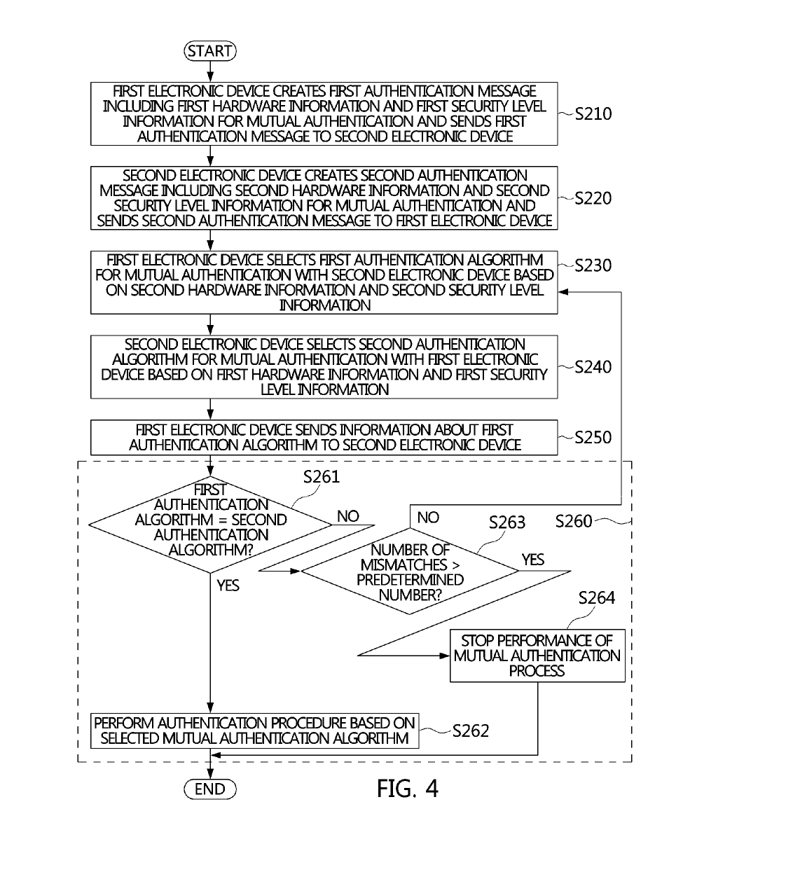

FIG. 4 is a flowchart that shows a method for mutual authentication between electronic devices according to an embodiment of the present invention.

Referring to FIG. 4, the method for mutual authentication between electronic devices according to an embodiment of the present invention may include creating, by a first electronic device, a first authentication message including first hardware information and first security level information for mutual authentication, and sending, by the first electronic device, the first authentication message to a second electronic device at step S210; creating, by the second electronic device, a second authentication message including second hardware information and second security level information for mutual authentication, and sending, by the second electronic device, the second authentication message to the first electronic device at step S220; selecting, by the first electronic device, a first authentication algorithm for mutual authentication with the second electronic device based on the second hardware information and the second security level information at step S230; selecting, by the second electronic device, a second authentication algorithm for mutual authentication with the first electronic device based on the first hardware information and the first security level information at step S240; sending, by the first electronic device, information about the selected first authentication algorithm to the second electronic device at step S250; and performing, by the second electronic device, a mutual authentication process by comparing the information about the first authentication algorithm with information about the selected second authentication algorithm at step S260.

Also, step S260 may include determining whether the information about the first authentication algorithm matches the information about the second authentication algorithm at step S261; performing a mutual authentication process at step S262 when the information about the first authentication algorithm matches the information about the second authentication algorithm; when the information about the first authentication algorithm is not identical to the information about the second authentication algorithm, sending, by the second electronic device, a message indicating the mismatch between the two pieces of information to the first electronic device and determining whether the number of mismatches is greater than a predetermined number at step S263; and stopping the performance of the mutual authentication process at step S264 when the number of mismatches is greater than the predetermined number.

Meanwhile, if the number of mismatches is not greater than the predetermined number at step S263, step S230 may be performed again. Accordingly, the first electronic device may select an authentication algorithm that differs from the first authentication algorithm, and may send information about the newly selected authentication algorithm to the second electronic device.

In other words, steps S230, S240 and S250 may be repeatedly performed until the number of mismatches between the two pieces of information with regard to the authentication algorithms becomes greater than the predetermined number if the information about the first authentication algorithm differs from the information about the second authentication algorithm.

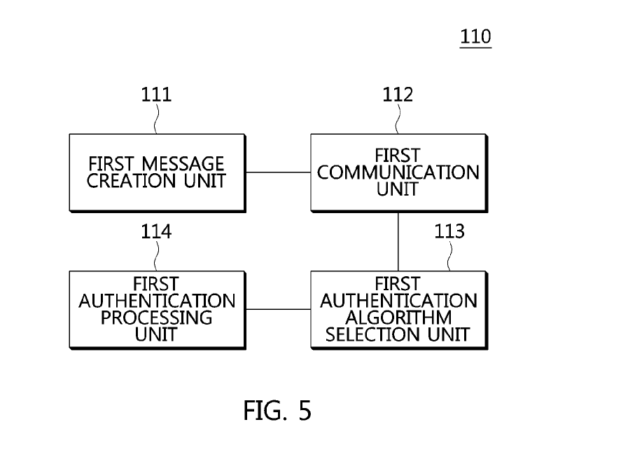

FIG. 5 is a block diagram that shows a first electronic device according to an embodiment of the present invention.

Referring to FIG. 5, the first electronic device 110 according to an embodiment of the present invention may include a first message creation unit 111, a first communication unit 112, a first authentication algorithm selection unit 113, and a first authentication processing unit 114.

The first message creation unit 111 may create a first authentication message that includes first hardware information and first security level information for mutual authentication.

For example, the first authentication message may be configured such that a field is added to a message that is generally sent and received between IoT devices so as to include the first hardware information and the first security level information therein. The first authentication message may include at least one of information about a random number for mutual authentication with a second electronic device 120 and identification information of the first electronic device 110. The first hardware information may indicate information about the hardware specification of the first electronic device 110, and the first security level information may indicate information about the security level of the first electronic device 110.

The first hardware information may include information about the characteristics of the resources or information about the IoT device type of the first electronic device 110. For example, the information about the characteristics of the resources may comprise information about the three classes (class 0, class 1, and class 2) into which electronic devices having limited resources are classified by the Internet Engineering Task Force (IETF) based on the data size and code size of the device. Also, the information about the IoT device type may comprise information about the four IoT device types (a data-carrying device, a data-capturing device, a sensing and actuating device and a general device) classified by the International Telecommunication Union Telecommunication Standardization Sector (ITU-T). The first hardware information may be defined by assigning a different identification number thereto based on the information about the characteristics of the resources or information about the IoT device type of the first electronic device 110.

The first security level information may be hierarchically defined depending on the security level of the first electronic device 110, and may be defined so as to have a different value depending on the security level thereof. For example, the first security level information may be defined so as to have different values depending on whether the security level is low or high. Here, the low level of security may be a security level in which a simple mathematical operation function or a hash algorithm is supported, whereas the high level of security may be a security level in which an asymmetric key algorithm or a device certificate is supported.

The first communication unit 112 may send the created first authentication message to the second electronic device 120. The first communication unit 112 may send information about the authentication algorithm selected by the first authentication algorithm selection unit 113 to the second electronic device 120. The first communication unit 112 may receive a second authentication message from the second electronic device 120. The second authentication message may include the hardware information and security level information of the second electronic device 120.

The first authentication algorithm selection unit 113 may select an authentication algorithm for mutual authentication with the second electronic device 120 based on the hardware information and the security level information of the second electronic device 120, which are included in the second authentication message received from the second electronic device 120. The first authentication algorithm selection unit 113 may select another authentication algorithm when receiving a message indicating a mismatch between the selected authentication algorithms from the second electronic device 120.

The first authentication processing unit 114 may perform a mutual authentication process using the authentication algorithm selected by the first authentication algorithm selection unit 113.

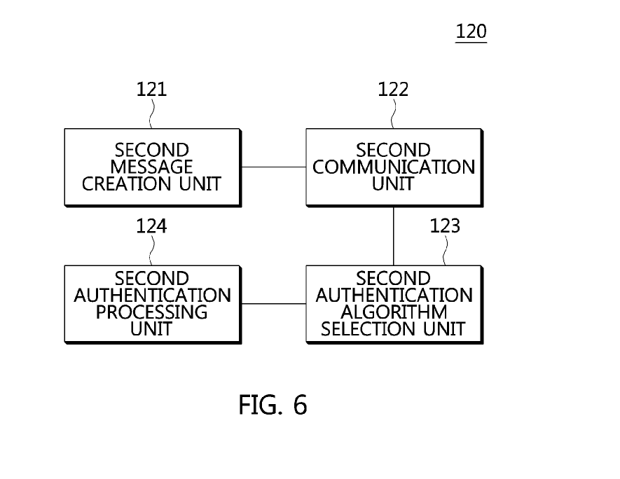

FIG. 6 is a block diagram that shows a second electronic device according to an embodiment of the present invention.

Referring to FIG. 6, the second electronic device 120 according to an embodiment of the present invention may include a second message creation unit 121, a second communication unit 122, a second authentication algorithm selection unit 123, and a second authentication processing unit 124.

The second message creation unit 121 may create a second authentication message that includes second hardware information and second security level information for mutual authentication.

For example, the second authentication message may be configured such that a field is added to a message that is generally sent and received between IoT devices so as to include the second hardware information and the second security level information therein. The second authentication message may include at least one of information about a random number for mutual authentication with the first electronic device 110 and identification information of the second electronic device 120. The second hardware information may indicate information about the hardware specification of the second electronic device 120, and the second security level information may indicate information about the security level of the second electronic device 120.

The second hardware information may include information about the characteristics of the resources or information about the IoT device type of the second electronic device 120. For example, the information about the characteristics of the resources may comprise information about the three classes (class 0, class 1, and class 2) into which electronic devices having limited resources are classified the by Internet Engineering Task Force (IETF) based on the data size and code size of the device. Also, the information about the IoT device type may comprise information about the four IoT device types (a data-carrying device, a data-capturing device, a sensing and actuating device and a general device) classified by the International Telecommunication Union Telecommunication Standardization Sector (ITU-T). The second hardware information may be defined by assigning a different identification number thereto based on the information about the characteristics of the resources or information about the IoT device type of the second electronic device 120.

The second security level information may be hierarchically defined depending on the security level of the second electronic device 120, and may be defined so as to have a different value depending on the security level thereof. For example, the second security level information may be defined so as to have different values depending on whether the security level is low or high. Here, the low level of security may be a security level in which a simple mathematical operation function or a hash algorithm is supported, whereas the high level of security may be a security level in which an asymmetric key algorithm or a device certificate is supported.

The second communication unit 122 may send the created second authentication message to the first electronic device 110. The second communication unit 122 may send information about the authentication algorithm selected by the second authentication algorithm selection unit 123 to the first electronic device 110. The second communication unit 122 may receive a first authentication message from the first electronic device 110. The first authentication message may include the hardware information and the security level information of the first electronic device 110. The second communication unit 122 may receive information about the algorithm (i.e., the first authentication algorithm) selected by the first electronic device 110.

The second authentication algorithm selection unit 123 may select an authentication algorithm for mutual authentication with the first electronic device 110 based on the hardware information and the security level information of the first electronic device 110, which are included in the first authentication message received from the first electronic device 110. For example, the second authentication algorithm selection unit 123 may select the authentication algorithm in the same manner as the first authentication algorithm selection unit 113 of the first electronic device 110.

The second authentication processing unit 124 may perform a mutual authentication process by comparing the information about the first authentication algorithm with the information about the second authentication algorithm. Specifically, the second authentication processing unit 124 may perform the mutual authentication process when the information about the first authentication algorithm matches the information about the second authentication algorithm. When the information about the first authentication algorithm is not identical to the information about the second authentication algorithm, the second authentication processing unit 124 may send a message indicating the mismatch between the two pieces of information to the first electronic device 110 through the second communication unit 122.

The second authentication processing unit 124 determines whether the number of mismatches between the information about the first authentication algorithm and the information about the second authentication algorithm is greater than a predetermined number, and may stop the performance of the mutual authentication process when the number of mismatches is greater than the predetermined number. For example, the predetermined number may be set based on the information about the hardware specification of the second electronic device 120. Specifically, when the second electronic device 120 is a low-performance device, the predetermined number may be set to be lower in order to reduce the consumption of electric power, whereas when the second electronic device 120 is a high-performance device, the predetermined number may be set to be greater.

The electronic devices and the method for performing authentication between electronic devices according to an embodiment of the present invention enable devices to conveniently and securely perform authentication therebetween by setting authentication levels autonomously based on predetermined hardware information and security level information when the devices communicate with each other in an IoT environment.

The above description merely illustrates the technical spirit of the present invention, and those skilled in the art may make various changes and modifications without departing from the scope of the present invention.

Accordingly, the embodiments, having been disclosed in the present invention, are intended not to limit but to describe the technical spirit of the present invention, and the scope of the technical spirit of the present invention is not limited to the embodiments. The scope of the protection of the present invention must be interpreted by the accompanying claims, and all the technical spirits in the same range as the claims must be interpreted as being included in the scope of rights of the present invention.

What is claimed is:

1. An electronic device, comprising:
a message creation unit for creating an authentication message including hardware information and security level information for mutual authentication with an additional electronic device;
a communication unit for sending the authentication message to the additional electronic device and receiving an authentication message of the additional electronic device from the additional electronic device;
an authentication algorithm selection unit for selecting an authentication algorithm for mutual authentication with the additional electronic device based on hardware information and security level information of the additional electronic device, which are included in the authentication message of the additional electronic device; and
an authentication processing unit for performing a mutual authentication process using the selected authentication algorithm.

2. The electronic device of claim 1, wherein the authentication message created by the message creation unit further includes at least one of information about a random number for mutual authentication with the additional electronic device and identification information of the electronic device.

3. The electronic device of claim 1, wherein the communication unit sends information about the selected authentication algorithm to the additional electronic device.

4. The electronic device of claim 1, wherein the hardware information includes information about characteristics of resources of the electronic device or IoT device type information of the electronic device.

5. The electronic device of claim 4, wherein the hardware information is defined differently depending on the information about the characteristics of the resources of the electronic device or the IoT device type information of the electronic device.

6. The electronic device of claim 1, wherein the security level information has different values depending on a security level of the electronic device.

7. The electronic device of claim 6, wherein the security level information is hierarchically defined depending on the security level of the electronic device.

8. An electronic device, comprising:
a message creation unit for creating an authentication message including hardware information and security level information for mutual authentication with an additional electronic device;
a communication unit for sending the authentication message to the additional electronic device and receiving an authentication message of the additional electronic device and information about a mutual authentication algorithm selected by the additional electronic device from the additional electronic device;
an authentication algorithm selection unit for selecting an authentication algorithm for mutual authentication with the additional electronic device based on hardware information and security level information of the additional electronic device, which are included in a message of the additional electronic device; and
an authentication processing unit for performing a mutual authentication process by comparing the selected authentication algorithm with the information about the mutual authentication algorithm received from the additional electronic device.

9. The electronic device of claim 8, wherein the authentication processing unit performs the mutual authentication process when the selected authentication algorithm matches a mutual authentication algorithm based on the information about the mutual authentication algorithm received from the additional electronic device.

10. The electronic device of claim 8, wherein the authentication processing unit sends a message indicating a mismatch between the selected authentication algorithm and a mutual authentication algorithm to the additional electronic device through the communication unit when the selected authentication algorithm is not identical to the mutual authentication algorithm based on the information about the mutual authentication algorithm received from the additional electronic device.

11. The electronic device of claim 10, wherein the authentication processing unit stops performance of the mutual authentication process when a number of cases in which the selected authentication algorithm is not identical to an authentication algorithm, based on mutual authentication algorithm information repeatedly received from the additional electronic device, is greater than a predetermined number.

12. A method for mutual authentication between electronic devices, comprising:
creating, by a first electronic device, a first authentication message including first hardware information and first security level information for mutual authentication and sending, by the first electronic device, the first authentication message to a second electronic device;
creating, by the second electronic device, a second authentication message including second hardware information and second security level information for mutual authentication and sending, by the second electronic device, the second authentication message to the first electronic device;
selecting, by the first electronic device, a first authentication algorithm for mutual authentication with the second electronic device based on the second hardware information and the second security level information;
selecting, by the second electronic device, a second authentication algorithm for mutual authentication with the first electronic device based on the first hardware information and the first security level information;
sending, by the first electronic device, information about the selected first authentication algorithm to the second electronic device; and
performing, by the second electronic device, a mutual authentication process by comparing the information about the first authentication algorithm with information about the selected second authentication algorithm.

13. The method of claim 12, wherein the first authentication message further includes at least one of information about a random number for mutual authentication with the second electronic device and identification information of the first electronic device, and the second authentication message further includes at least one of information about a random number for mutual authentication with the first electronic device and identification information of the second electronic device.

14. The method of claim 12, further comprising:
performing, by the first electronic device, the mutual authentication process using the selected first authentication algorithm.

15. The method of claim 12, wherein performing, by the second electronic device, the mutual authentication process is configured to perform the mutual authentication process when the information about the selected second authentication algorithm matches the information about the first authentication algorithm.

16. The method of claim 12, wherein performing, by the second electronic device, the mutual authentication process is configured such that, when the information about the selected second authentication algorithm is not identical to the information about the first authentication algorithm, a message indicating a mismatch between the two pieces of information is sent to the first electronic device.

17. The method of claim 16, wherein, when the first electronic device receives the message indicating the mismatch from the second electronic device, selecting the first authentication algorithm is repeatedly performed, but an authentication algorithm other than the first authentication algorithm is selected.

18. The method of claim 17, wherein performing, by the second electronic device, the mutual authentication process is configured to stop the mutual authentication process when a number of cases in which information about the newly selected authentication algorithm is not identical to the information about the second authentication algorithm is greater than a predetermined number.
